(19) United States
(12) Patent Application Publication
(10) Pub. No.: US 2022/0245520 A1
(43) Pub. Date: Aug. 4, 2022

(54) Systems and Methods for Generating and Providing Suggested Actions

(71) Applicant: Google LLC, Mountain View, CA (US)

(72) Inventors: Tim Wantland, Bellevue, WA (US); Melissa Lauren Barnhart, San Francisco, CA (US); Brian L. Jackson, Seattle, WA (US)

(21) Appl. No.: 17/622,465

(22) PCT Filed: Aug. 2, 2019
(86) PCT No.: PCT/US2019/044900

§ 371 Date: Dec. 23, 2021

(51) Int. Cl. G06N 20/00; G06F 40/30; G06F 3/0482

(52) U.S. Cl. CPC G06N 20/00; G06F 3/0488; G06F 3/0482; G06F 40/30

(57) ABSTRACT

A computing system can include an artificial intelligence system including one or more machine-learned models that are configured to receive a model input that includes context data, and, in response, output a model output that describes one or more semantic entities referenced by the context data. The computing system can be configured to obtain the context data during a first time interval; input the model input that includes the context data into the machine-learned model(s); receive, as an output of the machine-learned model(s), the model output that describes the one or more semantic entities referenced by the context data; store the model output in at least one tangible, non-transitory computer-readable medium; and provide, for display in a user interface during a second time interval that is after the first time interval, a suggested action with respect to the semantic entity or entities described by the model output.

### FIELD

The present disclosure relates generally to artificial intelligence systems. More particularly, the present disclosure relates to systems and methods for generating and providing suggested actions to a user of a computing device.

### BACKGROUND

Artificial intelligence and machine learning has been used to assist users of computing devices, for example by providing artificial intelligence agents and personal assistants. Such artificial intelligence agents and personal assistants, however, lack the ability to proactively assist users with remembering actions or items.

### SUMMARY

Aspects and advantages of embodiments of the present disclosure will be set forth in part in the following description, or can be learned from the description, or can be learned through practice of the embodiments.

One aspect of the present disclosure is directed to a computing system including at least one processor and an artificial intelligence system including one or more machine-learned models. The one or more machine-learned models can be configured to receive a model input that includes context data, and, in response to receipt of the model input, output a model output that describes one or more semantic entities referenced by the context data. The computing system can include at least one tangible, non-transitory computer-readable medium that stores instructions that, when executed by the at least one processor, cause the at least one processor to perform operations. The operations can include obtaining the context data during a first time interval; inputting the model input that comprises the context data into the one or more machine-learned models; receiving, as an output of the one or more machine-learned models, the model output that describes the one or more semantic entities referenced by the context data; storing the model output in the at least one tangible, non-transitory computer-readable medium; and providing, for display in a user interface during a second time interval that is after the first time interval, a suggested action with respect to the one or more semantic entities described by the model output.

Another aspects of the present disclosure to directed to a computer-implemented method for generating and providing suggested actions. The method can include obtaining, by one or more computing devices, context data during a first time interval. The method can include inputting, by the one or more computing devices, a model input that includes the context data into one or more machine-learned models that are configured to receive the model input that comprises context data, and, in response to receipt of the model input, output a model output that describes one or more semantic entities referenced by the context data. The method can include receiving, by the one or more computing devices, as an output of the one or more machine-learned models, the model output that describes the one or more semantic entities referenced by the context data. The method can include storing, by the one or more computing devices, the model output in at least one tangible, non-transitory computer-readable medium. The method can include providing, by the one or more computing devices for display in a user interface of the one or more computing devices during a second time interval that is after the first time interval, a suggested action with respect to the one or more semantic entities described by the model output.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a block diagram of an example computing system for generating and providing suggested actions to users of computing systems according to example embodiments of the present disclosure.

FIG. 1B depicts a block diagram an example computing system for generating and providing suggested actions to users of computing systems according to example embodiments of the present disclosure.

FIG. 1C depicts a block diagram of an example computing system for generating and providing suggested actions to users of computing systems according to example embodiments of the present disclosure.

FIG. 2 depicts an example artificial intelligence system for generating and providing suggested actions according to example embodiments of the present disclosure.

FIG. 3 depicts an example computing system for generating and providing suggested actions according to example embodiments of the present disclosure including one or more computer applications.

FIG. 4 depicts an example suggested action according to aspects of the present disclosure.

FIGS. 5A, 5B, and 5C depict additional example suggested actions according to aspects of the present disclosure.

FIG. 6 depicts an example panel including multiple suggested actions being displayed in a lock screen of a computing device according to aspects of the present disclosure.

FIG. 7 depicts computing device displaying an example notification panel displaying a suggested actions with notifications.

FIG. 8 depicts a computing device in a first state in which a plurality of category labels corresponding with categorized suggested actions are displayed according to aspects of the present disclosure.

FIG. 9 depicts the computing device of FIG. 8 in which one category label of the plurality of category labels has been selected and suggested actions corresponding with the selected category label are displayed according to aspects of the present disclosure.

FIG. 10 depicts a suggested action in which the semantic entity has been selected and search is being performed in response to the semantic entity being selected according to aspects of the present disclosure.

FIG. 11 depicts a computing system displaying a settings panel in which the user can select a default computer application for a type of suggested action.

FIG. 12 depicts a flowchart of a method for generating and providing suggested actions to users of computing systems according to aspects of the present disclosure.

### DETAILED DESCRIPTION

### Overview

Generally, the present disclosure is directed to an artificial intelligence system for identifying information of interest, storing the information, and providing suggested actions to users of computing systems at a later time based on the stored information. The artificial intelligence system can be configured to intelligently process information on behalf of the user, including, for example, visual and/or audio information that is displayed, played, and/or otherwise processed or detected by the computing device. In other words, the artificial intelligence system can capture information of interest as the computing device is used to perform tasks throughout the day. For example, the artificial intelligence system can identify and store semantic entities while the user navigates between various computer applications and/or switches between different tasks or activities. Alternatively, the artificial intelligence system can identify and store semantic entities referenced or included in a surrounding environment of the user (e.g., through analysis of captured imagery, audio, or other data regarding the surrounding environment. Thus, the artificial intelligence system can capture and process information (e.g., to identify semantic entities) that is actively identified or emphasized by a user while in other instances the artificial intelligence system can capture and process information (e.g., to identify semantic entities) that is simply referenced by or included in the ambient environment of the user (e.g., information that is contained in the surrounding environment but not specifically actively identified or emphasized by the user).

The artificial intelligence system can save or otherwise retain data associated with semantic entities as they are recognized over time. For example, the saved semantic entities can be ranked, sorted, categorized, prioritized etc. based on the user's preferences and/or the user's plans or schedule. As another example, the artificial intelligence system can generate one or more suggested actions for a user that are related to one or more of the identified semantic entities. For example, the suggested actions can include actions that can be taken by the artificial intelligence system and/or a computer application under direction of the artificial intelligence system for and/or on behalf of the user relative to the identified semantic entities. As examples, the suggested actions can include communications actions (e.g., emailing a certain contact), information retrieval actions (e.g., retrieving options to purchase or shop for a certain item, providing an opportunity to listen to a certain song, accessing geographic information such as the location of a point of interest), a booking action (e.g., requesting a ride share vehicle or purchasing a flight ticket), information storage (e.g., note-taking or inserting an item into a user's calendar), and/or many other suggested actions.

At a later time, the saved suggested actions can be provided for display. For example, the suggested actions can be accessed by the user via a specific menu, can be provided in a notifications menu, can be automatically surfaced at later, contextually relevant times, and/or can be accessed in other manners. The suggested actions can include links or buttons to perform the suggested actions (e.g., with computer applications). The user can also optionally provide feedback and/or instructions to the artificial intelligence system to customize how the artificial intelligence system captures information and/or suggests actions. Alternatively, the artificial intelligence system can also learn the user's preferences based on how the user interacts with the suggested actions.

Importantly, the user can be provided with controls allowing the user to make an election as to both if and when systems, programs, or features described herein may enable collection of user information (e.g., ambient audio, text presented in the user interface, etc.). In addition, certain data may be treated in one or more ways before it is stored or used, so that personally identifiable information is removed. For example, a user's identity may be treated so that no personally identifiable information can be determined for the user. Thus, the user may have control over what information is collected about the user, how that information is used, and what information is provided to the user.

Aspects of the present disclosure are directed to an artificial intelligence system that operates over multiple different time periods to provide suggested actions that are contextually meaningful. In particular, the artificial intelligence system can identify the semantic entities over a first time interval, store the semantic entities, and then display the suggested actions during a second time interval that is after the first time interval. For example, the suggested actions can act as reminders for the user during the second time interval to complete a task that the user started earlier. In this manner, aggregating relevant information over a first time interval and then providing multiple suggested actions based on the information during a second, later time interval can be less disruptive to the user. This can also be more useful to the user as the user is more likely to have forgotten about the task after some time has passed. Thus, by storing suggested and contextually-derived actions for later use, the artificial intelligence system can operate as a intelligent memory assistant which assist the user in remembering actions which they may want to take based on activities they engaged in earlier that day, week, month, etc.

As one example, the user can take a “screenshot” of an item while shopping in a first time interval. In response to this user action, the artificial intelligence system can generate and store a name or description of the item. Later, the user can suggest a specific meeting time and day during a phone call. The artificial intelligence system can generate and store a second semantic entity that can include the name of the person, the meeting time, etc. During the second time interval (e.g., after work, after dinner, etc.) the artificial intelligence system can display suggested actions with respect to the each of the item from the screenshot and the suggested meeting. The suggested action for the item can include purchasing the item displayed in the screenshot, and the suggested action for the meeting can include creating a calendar event based on the information gathered during the phone call.

In some implementations, the artificial intelligence system can generate the suggested action(s) based on a template (e.g., a predefined template). Utilizing a template can reduce the computing resources required to generate such suggested actions. Instead of training and utilizing a machine-learned model to generate the complete suggested action, keywords of the suggested action can be generated using the machine-learned model(s) and then assembled according to the template to generate the suggested action. For example, the template can include a verb, a semantic entity described by a model output of the machine-learned model, and a computer application, for example as follows:

[Verb]+[Semantic Entity]+[Computer Application]

The artificial intelligence system can select an appropriate verb and computer application to be inserted into the respective placeholders of the template. One example of a suggested action generated based on the above template is “Add Appt. with Dr. Sherrigan to Calendar.” It should be understood that a variety of templates can be employed. Furthermore, the artificial intelligence system can learn the user's preferences with respect to which templates to use and/or whether to use templates. Thus, the systems and methods described herein can employ one or more templates to generate the suggested actions.

In some implementations, the same template or template(s) can be used to generate multiple suggested actions such that the multiple suggested actions have the same general look and feel to the user. As such, the user can quickly evaluate the suggested actions because they are presented in a known and predictable format to the user. Thus, the templates as described herein can facilitate greater use of the suggested actions.

The systems and methods herein can leverage one or more machine-learned models according to aspects of the present disclosure. More specifically, the artificial intelligence system can include one or more machine-learned models that are configured to receive a model input that includes context data (e.g., ambient audio, information displayed in a screen of the computing device, etc.). The computing system can be configured to obtain the context data and input the model input that includes the context data into the machine-learned model. The computing system can receive, as an output of the machine-learned model, model output that describes one or more semantic entities referenced by the context data. The computing system can store the model output in at least one tangible, non-transitory computer-readable medium. The computing system can provide a suggested action with respect to the one or more semantic entity.

The context data discussed herein can include a variety of information, such as information currently displayed in the user interface, information previously displayed in the user interface, information gleaned from the user's previous actions (e.g., text written or read by the user, content viewed by the user, etc.), and/or the like. The context data can include user data that describes a preference or other information associated with the user and/or contact data that describes preferences or other information associated with a contact of the user. Example context data can include a message received by the computing system for the user, the user's previous interactions with one or more of the user's contacts (e.g., a text message mentioning a user preference for a restaurant or type of food), previous interactions associated with a location (e.g., going to a park, museum, other attraction, etc.), a business, etc. (e.g., posting a review for a restaurant, reading a menu of a restaurant, reserving a table at a restaurant, etc.), and/or any other suitable information about the user's preferences or user. Further examples include audio played or processed by the computing system, audio detected by the computing system, information about the user's location (e.g., a location of a mobile computing device of the computing system), and/or calendar data. For instance, context data can include ambient audio detected by a microphone of the computing system and/or phone audio processed during a phone call. Calendar data can describe future events or plans (e.g., flights, hotel reservations, dinner plans etc.). Example semantic entities that can be described by the model output can include words or phrases recognized in the text and/or audio. Additional examples can includes information about the user's location, such as a city name, state name, street name, names of nearby attractions, and the like.

In some implementations, multiple suggested actions can be displayed together in the second time interval after the context data is collected during the first time interval. More specifically, at least one additional suggested action can be displayed in the user interface with the suggested action. The additional suggested action(s) can be distinct from the suggested action. The additional suggested action(s) can also be generated and stored (e.g., during the first time) by the artificial intelligence system based on distinct semantic entities. For example, the artificial intelligence system can obtain additional context data that is distinct from the context data and input additional model input(s) that include the additional context data into the machine-learned model(s). The artificial intelligence system can receive, as an additional output of the machine-learned model(s), data descriptive of the additional suggested action(s) that is described by the additional suggested action(s). Thus, the artificial intelligence system can leverage the machine-learned model(s) to store multiple semantic entities over the first time interval and then display multiple suggested actions during the second time interval.

In some implementations, the artificial intelligence system can rank, sort, categorize, and prioritize, etc. the suggested actions, for example, based on the user data. The user data can include user preferences, calendar data (e.g., the user's plans or schedule), and/or other information about the user or the computing device. For example, the artificial intelligence system can rank the suggested actions and arrange the suggested actions within the user interface based on the ranking. Thus, the artificial intelligence system can prioritize the suggested actions and selectively display a group of the most important and/or relevant suggested actions to the user in the user interface.

In some implementations, the artificial intelligence system can categorize the suggested actions with respect to a plurality of categories. Category labels can be displayed in the user interface corresponding with the categories such that the user can navigate between the categories of suggested actions using the category labels (e.g., in separate panels or pages). For example, the computing system can detect a user touch action with respect to one category label. In response to detecting the user touch action, the computing system can display suggested actions that were categorized with respect to the selected suggested action. Thus, the artificial intelligence system can categorize the suggested actions and provide an intuitive way for the user to navigate between the categories of suggested actions for selection by the user.

In some implementations, the computing system can display explanations with respect to the suggested actions. The explanations can describe information about obtaining the context data, including, as examples, a time when the context data was obtained, a location of the computing device when the context data was obtained, and/or a source of the context data. As an example, the explanation can indicate that the suggested action was generated based on audio from a phone conversation with a specific user contact that occurred at a specific time. As another example, the explanation can indicate that the suggested action was generated based on a user's shopping session with a specific shopping application at a specific time. The source(s) of the data can include a computer application that was being displayed when the context data was obtained; whether the context data was obtained from ambient audio, text, graphical information, etc.; and/or any other information associated with obtaining the context data. Such explanations can provide the user with a better understanding of the operations of the artificial intelligence system. As a result, the user may be more comfortable with or trusting of the artificial intelligence system operations, which can make the artificial intelligence system more useful.

In some implementations, the computing system can provide the user with a way to view additional information associated with obtaining the context data in addition to the explanation(s). For example, the computing system can detect a user touch input that requests additional information with respect to the explanation. In response to detecting the user touch input, the computing system can display additional explanation information about obtaining the context data. The additional explanation information can include a time when the context data was obtained or a location of the computing device when the context data was obtained. The additional explanation information can include a source of the context data (if not already displayed). The additional information can include information about other times that context data was obtained in a similar way (e.g., from the same source, at similar times, etc.).

In some implementations, the computing system can provide the user with a way to adjust preferences with respect to how the artificial intelligence system collects context data. The additional explanation information can also include preferences and/or rules with respect to when and how the artificial intelligence system can obtain the context data. The user can adjust the rules and/or preferences within the user interface.

The computing system can display the suggested action(s) automatically or in response to a user request and in a variety of locations. For example, a panel displaying the suggested action(s) can be displayed in a “lock screen” or “home screen” of the computing device. The panel can be accessible at a system level from a drop down panel, navigation bar, or the like. The panel can be automatically displayed at one or more regular times throughout the day. In other implementations, the artificial intelligence system can intelligently choose when to display the panel based on the user data (e.g., preferences) and/or context data. The artificial intelligence system can display the panel when the suggested actions would be most relevant to the user based on the content of the suggested actions.

In some implementations, the computing system can be configured to interface with one or more computer applications to provide suggested actions that can be performed with the computer application(s). The computing system can provide data descriptive of the model output of the machine-learned model(s) that describes the suggested action(s) to the computer application(s). The computing system can receive one or more application outputs respectively from the computing application(s) via a pre-defined application programming interface. The suggested action can describe at least one of the application output(s).

In some implementations, the user can select a portion of the suggested action (e.g., the semantic entity) to perform another action with respect to the selected portion of the suggested action that is distinct from the suggested action. As an example, in user response to detecting a user touch action directed towards the semantic entity of the suggested action, the computing system can display a panel including a search (e.g., a web search) of the semantic entity. Additional examples include editing the semantic entity, changing a computer application of the suggested action, editing details of the suggested action, and so forth. For instance, a suggested action can include shopping for a specific brand of a produce (e.g., grill) using a specific shopping application. The user can select the semantic entity (e.g., “Webster Classic Grill”) and manually edit the entity, for example to change the brand name or type of product. The user can change “Webster Classic Grill” to “Webster Classic Grill Cover” before selecting the suggested action to purchase or shop for the item using the shopping application. As another example, the user can change the shopping application.

As one example, the systems and methods of the present disclosure can be included or otherwise employed within the context of an application, a browser plug-in, or in other contexts. Thus, in some implementations, the models of the present disclosure can be included in or otherwise stored and implemented by a user computing device such as a laptop, tablet, or smartphone. As yet another example, the models can be included in or otherwise stored and implemented by a server computing device that communicates with the user computing device according to a client-server relationship. For example, the models can be implemented by the server computing device as a portion of a web service (e.g., a web email service).

For example, the systems and methods of the present disclosure may operate at the operating system level rather than that of one or more particular applications that require user selection to initiate their operations. For example, context data may be automatically acquired from one or more sources of the system, such as one or more of microphone(s), camera(s), webpages visited, location(s) of the system, and orientation(s) of the system during normal use of the system and without the user necessarily opening a particular application. The context data may be acquired so long as the system is switched on and/or when an appropriate passcode, password and/or biometric identifier is verified. The user is not required therefore to remember to initiate a particular function to acquire context data. The context data may automatically be stored on a system-level “clipboard.” The user may disable certain sources of the context data if desired.

For example, the systems and methods of the present disclosure may limit the amount of data that is stored on memory and/or which is allocated to such systems and methods. For example, the systems and methods may automatically remove or overwrite acquired context data and/or suggested actions based on one or more rules. For example, context data that is older than a predetermined period, e.g. which is one day or one week old, may be removed or overwritten automatically. The rules, e.g. the predetermined period, may be user configurable. The predetermined period may be updated dynamically for particular context data and/or suggested actions based on prior user interactions. For example, prior user interactions may be user selections in relation to suggested actions. For example, if a user selects to create calendar appointments from suggested actions more frequently than opening a shopping application from suggested actions, the context data which is linked to shopping actions may be deleted or overwritten sooner than those for calendar appointments. A maximum limit may be placed on the amount of data that is stored so as to avoid taking away storage resources of application data. Where suggested actions are ranked in a priority order, only the top N suggested actions may be preserved for output.

For example, the systems and methods of the present disclosure may provide one or more suggested actions linked or associated with one or more applications, with at least one selectable button or the like being displayed alongside or otherwise with the suggested action to permit a single or reduced number of taps, touches or swipe gestures to effect the suggested action. Here, the number of physical user interactions to effect a suggested action, such as adding an appointment to a calendar event, playing a music or video track, opening a shopping website, etc. may require fewer user interactions with the user interface and/or use less electrical energy and processing resources than opening a particular application and making selections and/or entering data manually. For example, opening a shopping application or website for purchasing a particular product may be achieved using a single gesture, rather than opening the relevant shopping application or browser window, entering a search term and then selecting an item from a list of suggestions.

For example, the suggested action may be displayed in an associated portion of the user interface and, as well as having a selectable button or the like associated with initiation of the suggested action, one or more further buttons or the like may be presented in the same portion for single-touch initiation of related functions which ordinarily might require the application to be opened. For example, in relation to a suggested action that involves playing audio or video, as well as a suggested action to open a music or video application to play the audio or video, one or more further buttons or the like, associated with that application, might be presented, such as a “like” button or a “share” button, selection of which causes the associated action to be performed. For example, in relation to a suggested action to create a calendar appointment, if it is detected that the proposed appointment clashes with an existing one, one or more further buttons or the like may be provided to initiate cancelling and/or rescheduling the existing appointment.

Where the artificial intelligence system intelligently chooses when to display the panel based on the user data (e.g., user preferences) and/or context data, the artificial intelligence system can display the panel when the suggested actions would be most relevant, or less disturbing or intrusive to the user, based on the content of the suggested actions. For example, if the suggested actions comprise playing audio or video, then the artificial intelligence system may choose not to display such suggested actions during working hours, whereas “silent” suggested actions such as suggested appointments or suggested shopping actions may be displayed at said times. As mentioned, aggregating suggested actions until a later, second time interval, avoids overly disturbing the user and/or being intrusive.

For example, the systems and methods of the present disclosure may operate at the operating system level rather than that of one or more particular applications that require user selection to initiate their operations. For example, context data may be automatically acquired from one or more sources of the system, such as one or more of microphone(s), camera(s), webpages visited, location(s) of the system, and orientation(s) of the system during normal use of the system and without the user necessarily opening a particular application. The context data may be acquired so long as the system is switched on and/or when an appropriate passcode, password and/or biometric identifier is verified. The user is not required therefore to remember to initiate a particular function to acquire context data. The context data may automatically be stored on a system-level “clipboard.” However, the user may disable certain sources of the context data if desired.

For example, the systems and methods of the present disclosure may limit the amount of data that is stored on memory and/or which is allocated to such systems and methods. For example, the systems and methods may automatically remove or overwrite acquired context data and/or suggested actions based on one or more rules. For example, context data that is older than a predetermined period, e.g. which is one day or one week old, may be removed or overwritten automatically. The rules, e.g. the predetermined period, may be user configurable. The predetermined period may be updated dynamically for particular context data and/or suggested actions based on prior user interactions. For example, prior user interactions may include user selections in relation to suggested actions. For example, if a user selects to create calendar appointments from suggested actions more frequently than opening a shopping application from suggested actions, the context data which is linked to shopping actions may be deleted or overwritten sooner than those for calendar appointments. A maximum limit may be placed on the amount of data that is stored so as to avoid taking away storage resources of application data. Where suggested actions are ranked in a priority order, only the top N suggested actions may be preserved for output.

For example, the systems and methods of the present disclosure may provide one or more suggested actions linked or associated with one or more applications, with at least one selectable button or the like being displayed alongside or otherwise with the suggested action to permit a single or reduced number of taps, touches or swipe gestures to effect the suggested action. Here, the number of physical user interactions to effect a suggested action, such as adding an appointment to a calendar event, playing a music or video track, opening a shopping website, etc. may require fewer user interactions with the user interface and/or use less electrical energy and processing resources than opening a particular application and making selections and/or entering data manually. For example, opening a shopping application or website for purchasing a particular product may be achieved using a single gesture, rather than opening the relevant shopping application or browser window, entering a search term and then selecting an item from a list of suggestions.

For example, the suggested action may be displayed in an associated portion of the user interface and, as well as having a selectable button or the like associated with initiation of the suggested action, one or more further buttons or the like may be presented in the same portion for single-touch initiation of related functions which ordinarily might require the application to be manually opened by the user. For example, in relation to a suggested action that involves playing audio or video, as well as a suggested action to open a music or video application to play the audio or video, one or more further buttons or the like, associated with that application, might be presented, such as a “like” button or a “share” button. The selection of such a button can cause the associated action to be performed. For example, in relation to a suggested action to create a calendar appointment, if it is detected that the proposed appointment clashes with an existing one, one or more further buttons, or the like, may be provided to initiate cancelling and/or rescheduling the existing appointment.

Where the artificial intelligence system intelligently chooses when to display the panel based on the user data (e.g., preferences) and/or context data, the artificial intelligence system can display the panel when the suggested actions would be most relevant, or less disturbing or intrusive to the user, based on the content of the suggested actions. For example, if the suggested actions comprise playing audio or video, then the artificial intelligence system may choose not to display such suggested actions during working hours, whereas “silent” suggested actions such as suggested appointments or suggested shopping actions may be displayed at said times. As mentioned, aggregating suggested actions until a later, second time interval, avoids overly disturbing the user and/or being intrusive.

With reference now to the Figures, example embodiments of the present disclosure will be discussed in further detail.

### Example Devices and Systems

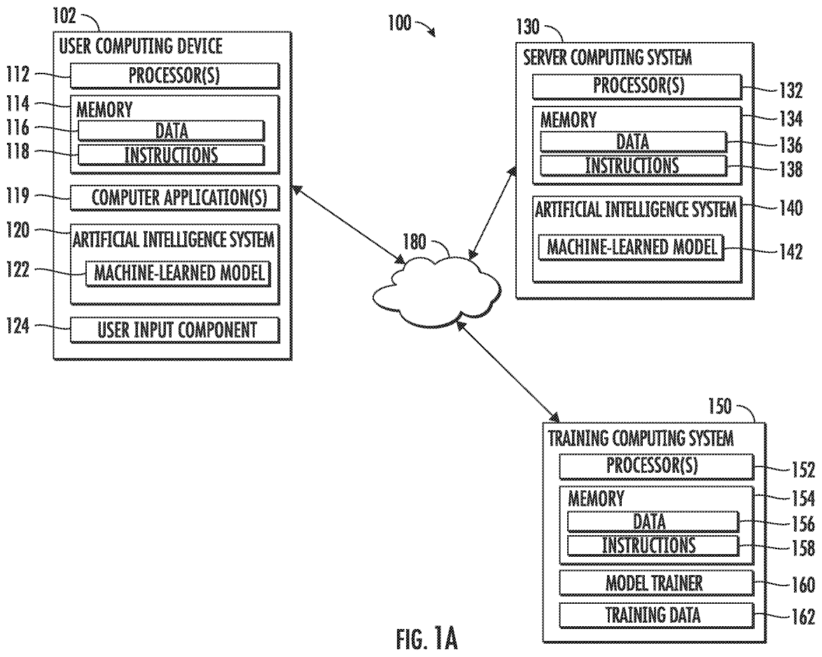

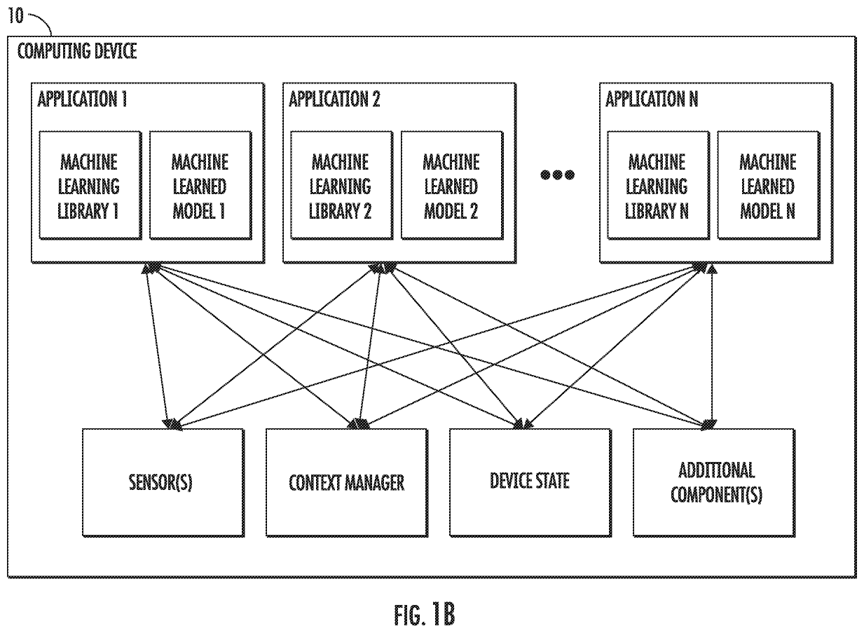

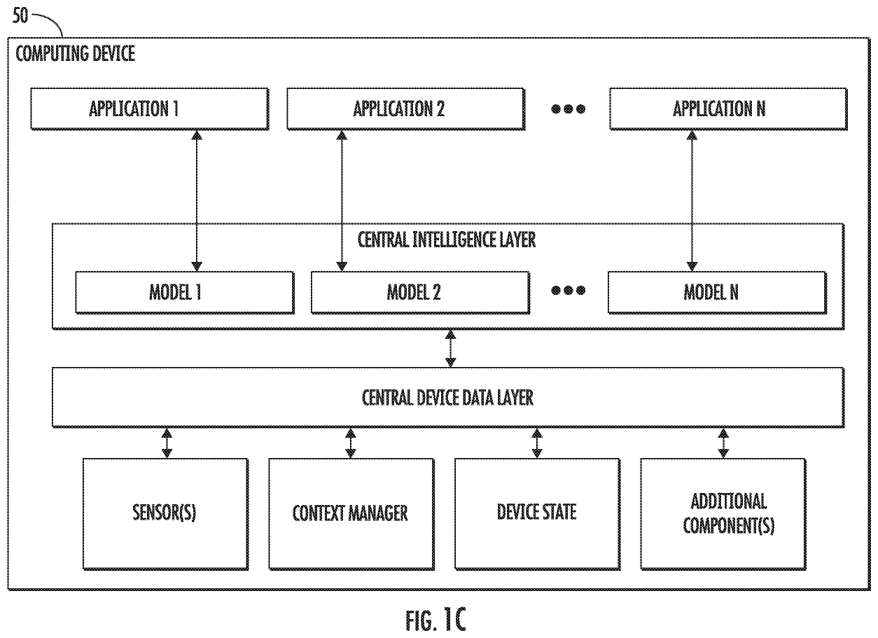

FIG. 1A depicts a block diagram of an example computing system 100 for generating and providing suggested actions according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

The user computing device 102 can store or include one or more computer applications 119. The computer application(s) 119 can be configured to perform various operations and provide application output(s) as described herein.

The user computing device 102 can store or include an artificial intelligence system 120. The artificial intelligence system 120 can perform some or all of the operations described herein. The artificial intelligence system 120 can be separate and distinct from the one or more computer applications 119 but can be capable of communicating with the one or more computer applications 119.

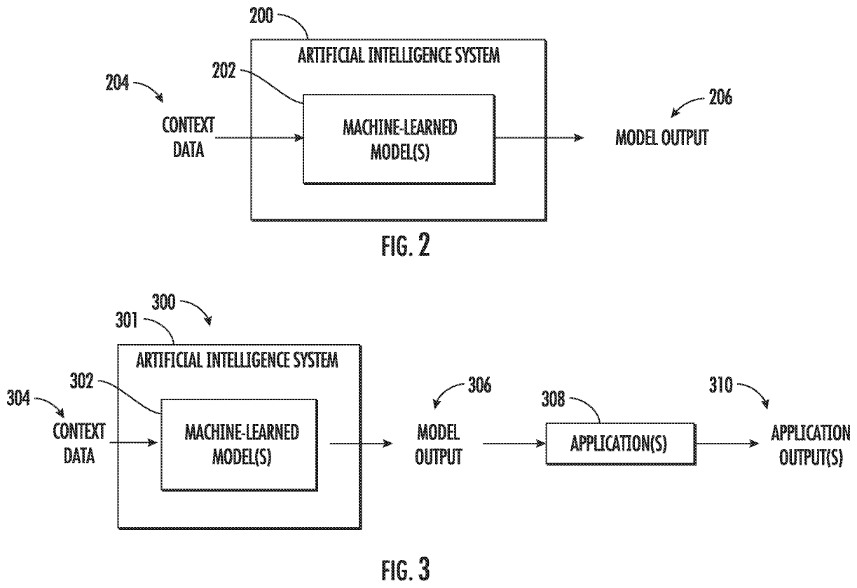

The user computing device 102 can store or include one or more machine-learned models 122. For example, the machine-learned models 122 can be or can otherwise include various machine-learned models such as neural networks (e.g., deep neural networks) or other multi-layer non-linear models. Neural networks can include recurrent neural networks (e.g., long short-term memory recurrent neural networks), feed-forward neural networks, or other forms of neural networks. Example machine-learned models 122 are discussed with reference to FIGS. 2 and 3.

In some implementations, the one or more machine-learned models 122 can be received from the server computing system 130 over network 180, stored in the user computing device memory 114, and the used or otherwise implemented by the one or more processors 112. In some implementations, the user computing device 102 can implement multiple parallel instances of a single machine-learned model 122 (e.g., to perform parallel operations across multiple instances of the machine-learned 120).

Additionally or alternatively, an artificial intelligence system 140 can be included in or otherwise stored and implemented by the server computing system 130 that communicates with the user computing device 102 according to a client-server relationship. For example, the artificial intelligence system 140 can include a machine-learned model 142. For example, the machine-learned models 142 can be implemented by the server computing system 140 as a portion of a web-based service. Thus, one or more models 122 can be stored and implemented at the user computing device 102 and/or one or more models 142 can be stored and implemented at the server computing system 130.

The user computing device 102 can also include one or more user input component 124 that receives user input. For example, the user input component 124 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can enter a communication.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise includes one or more machine-learned models 142. For example, the models 142 can be or can otherwise include various machine-learned models such as neural networks (e.g., deep recurrent neural networks) or other multi-layer non-linear models. Example models 142 are discussed with reference to FIGS. 2 and 3.

The server computing system 130 can train the models 142 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 142 stored at the server computing system 130 using various training or learning techniques, such as, for example, backwards propagation of errors. In some implementations, performing backwards propagation of errors can include performing truncated backpropagation through time. The model trainer 160 can perform a number of generalization techniques (e.g., weight decays, dropouts, etc.) to improve the generalization capability of the models being trained.

In some implementations, if the user has provided consent, the training data 162 can be obtained from the user computing device 102 (e.g., based on communications previously provided by the user of the user computing device 102). Thus, in such implementations, the model 122 provided to the user computing device 102 can be trained by the training computing system 150 on user-specific communication data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 1A illustrates one example computing system that can be used to implement the present disclosure. Other computing systems can be used as well. For example, in some implementations, the user computing device 102 can include the model trainer 160 and the training dataset 162. In such implementations, the models 122 can be both trained and used locally at the user computing device 102. In some of such implementations, the user computing device 102 can implement the model trainer 160 to personalize the models 122 based on user-specific data.

FIG. 1B depicts a block diagram of an example computing device 10 that can be used to implement the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 1B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 1C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 1C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 1C, the central device data layer can communicate with a number of other components of the computing device, such as, for example, one or more sensors, a context manager, a device state component, and/or additional components. In some implementations, the central device data layer can communicate with each device component using an API (e.g., a private API).

### Example Model Arrangements

FIG. 2 depicts a block diagram of an example artificial intelligence system 200 according to example embodiments of the present disclosure. The artificial intelligence system 200 can include one or more machine-learned model(s) 202 that are trained to receive context data 204 and, as a result of receipt of the context data 204, provide a model output 206 that describes one or more semantic entities referenced by the context data 204.

The context data 204 discussed herein can include a variety of information, such as information currently displayed in the user interface, information previously displayed in the user interface, information gleaned from the user's previous actions (e.g., text written or read by the user, content viewed by the user, etc.), and/or the like. The context data 204 can include user data that describes a preference or other information associated with the user and/or contact data that describes preferences or other information associated with a contact of the user. Example context data 204 can include a message received by the computing system for the user, the user's previous interactions with one or more of the user's contacts (e.g., a text message mentioning a user preference for a restaurant or type of food), previous interactions associated with a location (e.g., going to a park, museum, other attraction, etc.), a business, etc. (e.g., posting a review for a restaurant, reading a menu of a restaurant, reserving a table at a restaurant, etc.), and/or any other suitable information about the user's preferences or user. Further examples include audio played or processed by the computing system, audio detected by the computing system, information about the user's location (e.g., a location of a mobile computing device of the computing system), and/or calendar data. For instance, the context data 204 can include ambient audio detected by a microphone of the computing system and/or phone audio processed during a phone call. Calendar data can describe future events or plans (e.g., flights, hotel reservations, dinner plans etc.). Example semantic entities that can be described by the model output 206 can include words or phrases recognized in the text and/or audio. Additional examples can includes information about the user's location, such as a city name, state name, street name, names of nearby attractions, and the like.

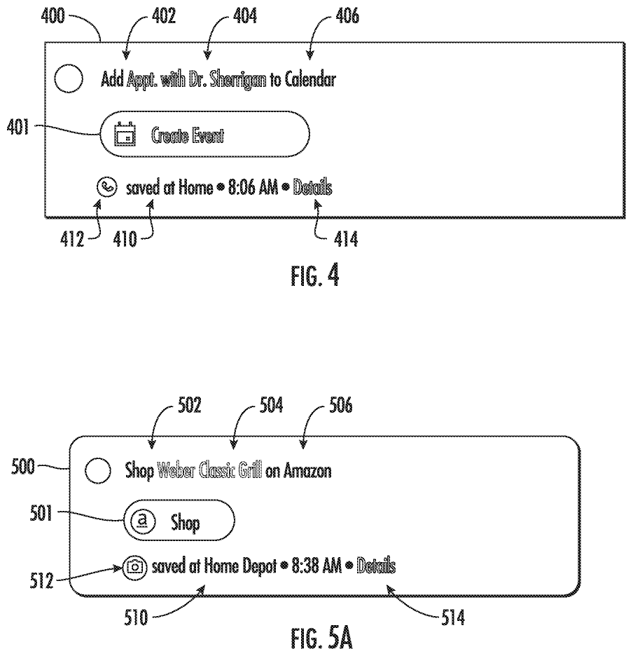

In some implementations, the model output 206 can more directly describe suggested actions. For example, the machine-learned model(s) 202 can be trained to output data that describes text of suggested actions (e.g., including a verb, application, and the semantic entity), for example as described with reference to FIGS. 4 through 9. A single machine-learned model 202 can be trained to receive the context data 204 and output such model output 206.

In some implementations, multiple machine-learned model(s) 202 can be trained (e.g., end-to-end) to produce such model output 206. For instance, a first model of the machine-learned models 202 can output data that describes a semantic entity included in the context data 204. A second model of the machine-learned model can receive the data that describes a semantic entity included in the context data 204 and output the model output 206 that describes the suggest action with respect to the semantic entity. The second machine-learned model(s) can additionally receive some or all of the context data 204. One or ordinary skill in the art would understand that additional configurations are possible within the scope of the present disclosure.

FIG. 3 depicts a block diagram of an example computing system 300 including an artificial intelligence system 301. The artificial intelligence system 301 can include one or more machine-learned model(s) 302 according to example embodiments of the present disclosure. The machine-learned model(s) 302 can be trained to receive context data 304 and, as a result of receipt of the context data 304, provide a model output 306 that describes one or more semantic entities referenced by the context data 304.

The computing system 300 can be configured to interface with one or more computer applications 308 to provide suggested actions that can be performed with the computer application(s) 308. The computing system 300 can provide data descriptive of the model output 306 of the machine-learned model(s) 302 that describes the suggested action(s) to the computer application(s) 308. The computing system 300 can receive one or more application outputs 310 respectively from the computing application(s) 308 via a pre-defined application programming interface. The suggested action can describe or correspond with at least one of the application output(s) 310.

FIG. 4 depicts an example suggested action 400 according to aspects of the present disclosure. The suggested action 400 can describe an available action that can be performed with a computer application. In this example, the suggested action 400 can include creating a calendar event with a calendar application. More specifically, in this example suggested action 400 includes the text “Add Appt. with Dr. Sherrigan to Calendar.” The computing system can be configured to perform this action can in response to receiving a user touch input requesting the same. For instance, the user can tap a button 401, slide a slider bar, or otherwise interact with the suggested action 400 to request that the computing system perform the action.

In some implementations, the artificial intelligence system can generate the suggested action(s) 400 based on a template (e.g., a predefined template). Utilizing a template can reduce the computing resources required to generate such suggested actions 400. Instead of training and utilizing a machine-learned model to generate all text of the suggested action 400, key words of the suggested action 400 can be generated using the machine-learned model(s) and then assembled according to the template to generate the suggested action 400. For example, the template can include respective placeholders for a verb 402, a semantic entity 404, and/or a computer application 406. The semantic entity 404 can be described by the model output 206 of the machine-learned model(s) 202, for example as described above with reference to FIG. 2. The template may be arranged as follows:

[Verb]+[Semantic Entity]+[Computer Application]

The artificial intelligence system can select an appropriate verb and/or computer application to be inserted into the respective placeholders of the template. The verb and/or computer application can be selected based on the context data and/or semantic entity. It should be understood that a variety of template variations can be employed within the scope of this disclosure. Furthermore, the artificial intelligence system can learn the user's preferences with respect to which templates to use and/or whether to use templates. Thus, the systems and methods described herein can employ one or more templates to generate the suggested actions.

In some implementations, the same template or template(s) can be used to generate multiple suggested actions such that the multiple suggested actions have the same general look and feel to the user. As such, the user can quickly evaluate the suggested actions because they are presented in a known and predictable format to the user. Thus, the templates as described herein can facilitate greater use of the suggested actions.

An explanation 410 can be displayed with respect to the suggested actions 400. The explanation 410 can describe information about obtaining the context data, including, as examples, a time when the context data was obtained, a location of the computing device when the context data was obtained, and/or a source of the context data. In this example, the explanation 410 states that the context data was “saved at Home” at “8:06 AM.” The explanation 410 can indicate a source of the context data used to generate the suggested action 400 by displaying an icon. In this example, the explanation 410 can include a phone icon 412 to indicate that the context data was collected from audio during a phone call. The explanation 410 may encourage the user to be more comfortable with or trusting of the artificial intelligence system operations, which can make the artificial intelligence system more useful to the user.

In some implementations, the computing system can provide the user with a way to view additional information associated with obtaining the context data in addition to the explanation 410. For example, the computing system can detect a user touch input that requests additional information with respect to the explanation 410. In this example, in response to receiving a user touch input directed to “Details” 414, the computing system can display additional explanation information about obtaining the context data. The additional explanation information can include a time when the context data was obtained or a location of the computing device when the context data was obtained. The additional explanation information can include a source of the context data (if not already displayed). The additional information can include information about other times that context data was obtained in a similar way (e.g., from the same source, at similar times, while the computing device was in the same location etc.).

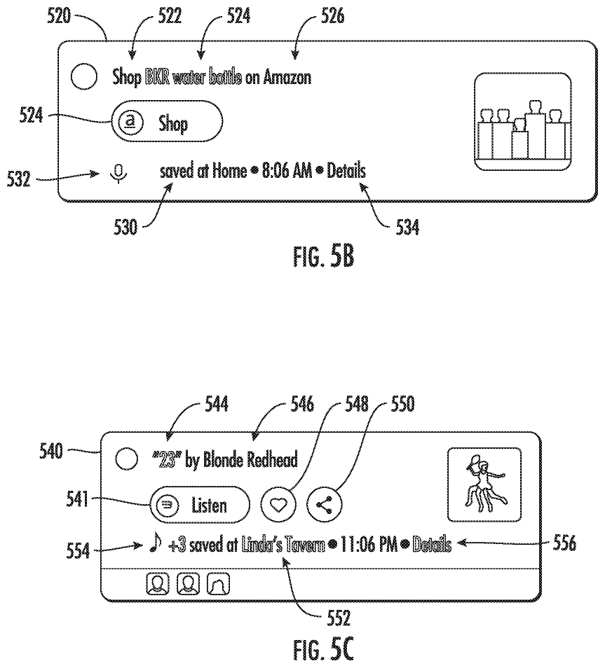

FIG. 5A depicts an additional example suggested action 500 according to aspects of the present disclosure. This example suggested action 500 describes an available action that can be performed with a shopping application. In this example, the suggested action 500 can include shopping for an item “Webster Classic Grill” using the shopping application. More specifically, in this example suggested action 500 includes the text “Shop Weber Classic Grill on Amazon.” This text can be generated based on a predefined template as described above with reference to FIG. 4. As discussed above, the template can include respective placeholders for a verb 502, a semantic entity 504, and a computer application 506. The computing system can be configured to perform this action in response to receiving a user touch input requesting the same. For instance, the user can tap a button 501, slide a slider bar, or otherwise interact with the suggested action 500 to request that the computing system perform the action.

An explanation 510 can be displayed with respect to the suggested actions 500 that describes information about obtaining the context data, including, as examples, a time and location of the computing device when the context data was obtained and/or a source of the context data. In this example, the explanation 510 states that the context data was “saved at Home Depot” at “8:38 AM.” The explanation 510 can indicate a source of the context data used to generate the suggested action 500, for example by displaying an icon 512. In this example, the icon 512 can indicate that the context data was obtained from an image (e.g., a photograph or screenshot). The explanation 510 may encourage the user to be more comfortable with or trusting of the artificial intelligence system operations, which can make the artificial intelligence system more useful to the user. The computing system can be configured to detect a user touch input that requests additional information with respect to the explanation 510. In this example, in response to receiving a user touch input directed to “Details” 514, the computing system can display additional explanation information about obtaining the context data.

FIG. 5B depicts an additional example suggested action 520 according to aspects of the present disclosure. In this example, the suggested action 520 can include shopping for an item using a shopping application: “Shop BKR water bottle on Amazon.” This text can be generated based on a predefined template as described above with reference to FIG. 4. As discussed above, the template can include respective placeholders for a verb 522, a semantic entity 524, and a computer application 526. The suggested action 520 can include a button 525 for performing the suggested action 520 and an explanation 530. In this example, the explanation 530 indicates the location and time when the context data was saved (e.g., “saved at home ⋅ 8:06 AM.”). The explanation 530 can indicate a source of the context data used to generate the suggested action 520 by displaying an icon 532. In this example, the icon 532 can indicate that the context data was obtained from audio (e.g., a voice memo or ambient audio). As indicated above, the explanation 530 may encourage the user to be more comfortable with or trusting of the artificial intelligence system operations, which can make the artificial intelligence system more useful to the user. The computing system can be configured to detect a user touch input that requests additional information with respect to the explanation 530. In this example, in response to receiving a user touch input directed to “Details” 534, the computing system can display additional explanation information about obtaining the context data.

FIG. 5C depicts an additional example suggested action 540 according to aspects of the present disclosure. This example suggested action 540 describes an available action that can be performed with a music streaming application. In this example, the suggested action 540 can include listening to a particular song 544 by a particular artist 546, which can correspond with the stored semantic entity. The user can tap a button 541 to perform the suggested action 540. Additionally, in this example, the suggested action 540 can include a save button 548 for saving the suggested action 540 for a later time and/or a share button 550 for sharing the suggested action, for example, via social media, text message, e-mail, etc.

An explanation 552 can be displayed with respect to the suggested actions 540 that describes information about obtaining the context data, including, as examples, a time and location of the computing device when the context data was obtained and/or a source of the context data. In this example, the explanation 552 states that the context data was “saved at Linda's Tavern” at “11:06 PM.” A portion of the explanation 552, such as the location “Linda's Tavern” can include a link, for example to further information about the location (e.g., a web search or map application search).

The explanation 552 can indicate a source of the context data used to generate the suggested action 540 by displaying an icon 554. In this example, the icon 554 can indicate that the context data was obtained from ambient music (e.g., detected by a microphone of the computing device). The explanation 552 may encourage the user to be more comfortable with or trusting of the artificial intelligence system operations, which can make the artificial intelligence system more useful to the user. The computing system can be configured to detect a user touch input that requests additional information with respect to the explanation 552. In this example, in response to receiving a user touch input directed to “Details” 556, the computing system can display additional explanation information about obtaining the context data.

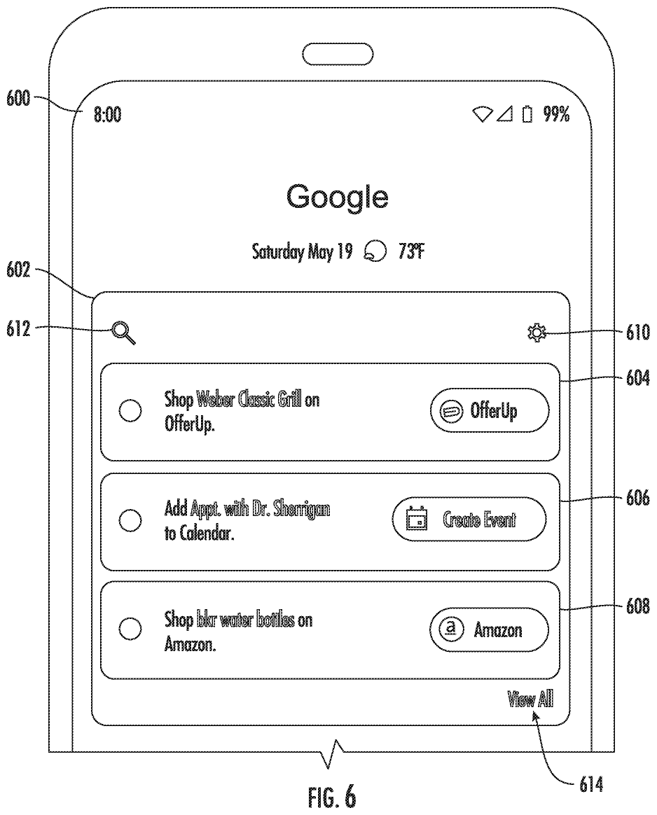

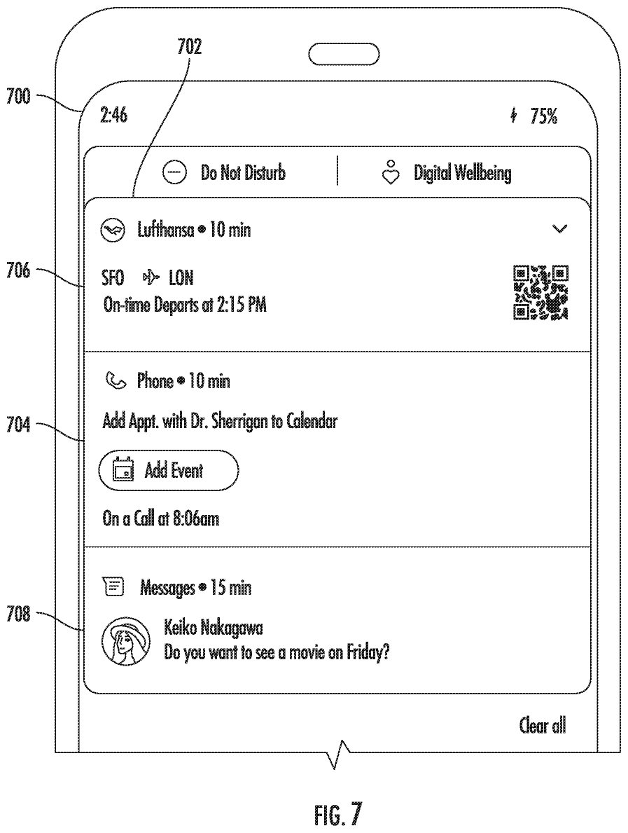

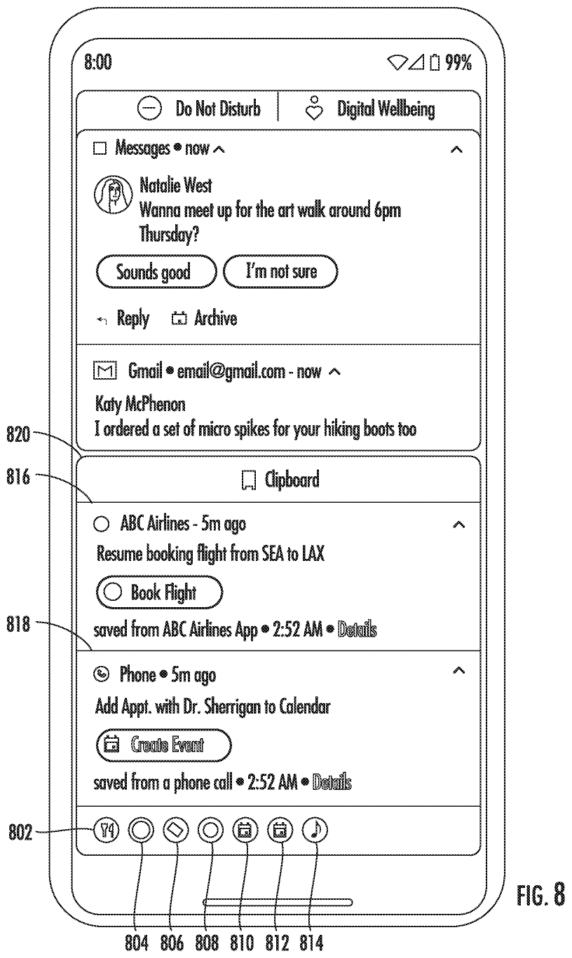

FIG. 6 depicts computing device 600 displaying an example panel 602 including multiple suggested actions 604, 606, 608 being displayed in a lock screen according to aspects of the present disclosure. The lock screen can be displayed when the computing device 600 is locked and requires authentication to access a main menu or perform other operations.

The multiple suggested actions 604, 606, 608 can be displayed together during a second time interval after the context data is collected during a first time interval. More specifically, at least one additional suggested action 606, 608 can be displayed in the user interface with the suggested action 604. The additional suggested action(s) 606, 608 can be distinct from the suggested action 604. The additional suggested action(s) 606, 608 can also be generated and stored (e.g., during the first time interval) by the artificial intelligence system based on distinct semantic entities. For example, the artificial intelligence system can obtain additional context data that is distinct from the context data and input additional model input(s) that include the additional context data into the machine-learned model(s). The artificial intelligence system can receive, as an additional output of the machine-learned model(s), data descriptive of the additional suggested action(s) that is described by the additional suggested action(s), for example as described above with reference to FIGS. 2 and 3. Thus, the artificial intelligence system can leverage the machine-learned model(s) to store multiple semantic entities over the first time interval (e.g., as the user goes about their day) and then display multiple suggested actions during the second time interval (e.g., at the end of the day).

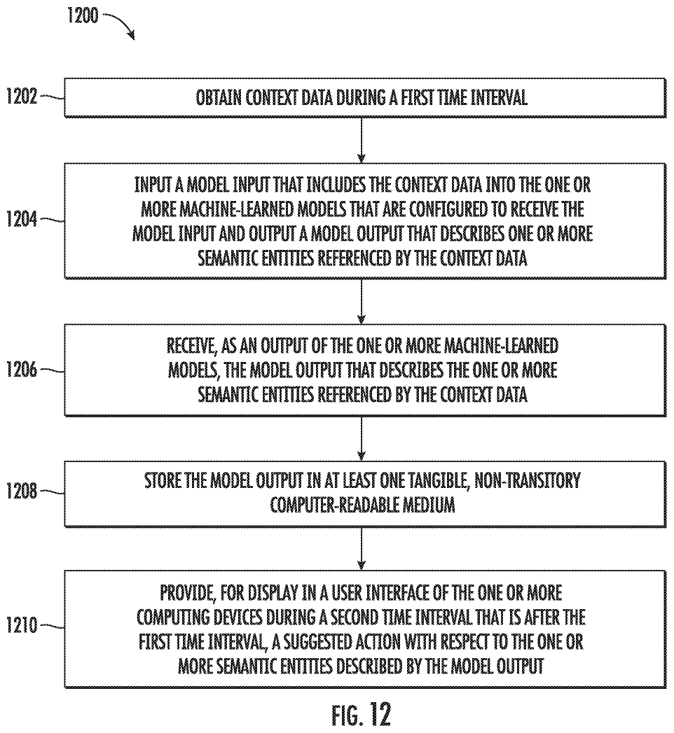

Additional buttons can also be displayed in the panel 602 for the user to control or manipulate the suggested actions 604, 606, 608 and/or adjust settings of the artificial intelligence system. As one example, a settings icon 610 can be displayed in the panel 602. In response to a user touch action directed to the settings icon 610, the computing system can display a settings panel, for example as described below with respect FIG. 11. The user can adjust the settings of the artificial intelligence system using the setting panel.

As another example, a search icon 612 can be displayed in the panel 602. In response to a user touch action directed to the search icon 612, the user can search through suggested actions that are not currently displayed in the panel 602.

As another example, a “view all” button 614 can be displayed in the panel 602. In response to a user touch action directed to the “view all” button 614, the user can view additional suggested actions that are not currently displayed in the panel 602.

FIG. 7 depicts computing device 700 displaying an example notification panel 702 displaying a suggested action 704 with notifications 706, 708. The notification panel 702 can be displayed automatically or in response to user input requesting that the notification panel 702 be displayed.

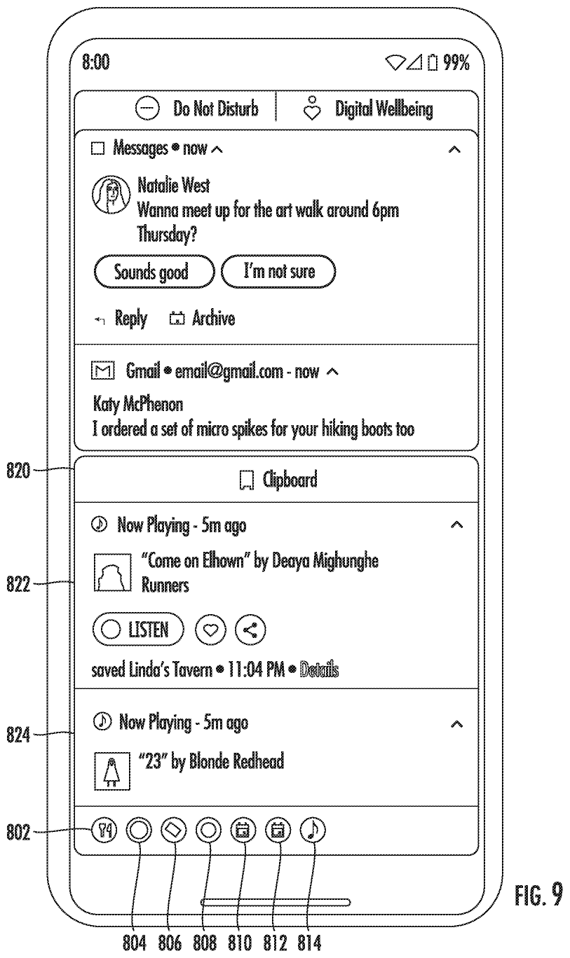

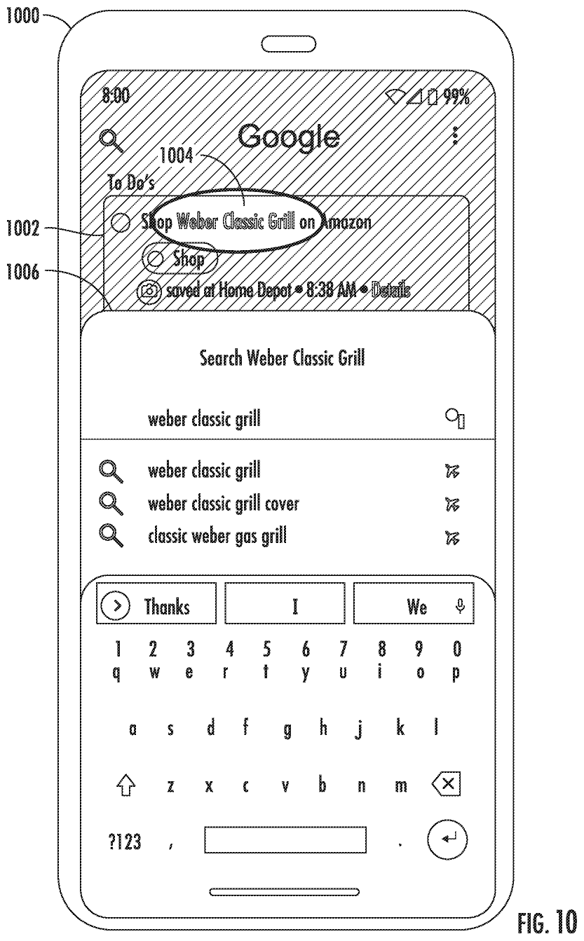

FIG. 8 depicts a computing device 800 in a first state in which a plurality of category labels 802, 804, 806, 808, 810, 812, 814 corresponding with categorized suggested actions are displayed according to aspects of the present disclosure. A plurality of suggested actions 816, 818 can be displayed in a panel 820 with the plurality of category labels 802, 804, 806, 808, 810, 812. The artificial intelligence system can categorize the suggested actions 816, 818, 822, 824 with respect to a plurality of categories corresponding with the plurality of category labels 802, 804, 806, 808, 810, 812, 814. Category labels 802, 804, 806, 808, 810, 812, 814 can be displayed in the user interface. The category labels 802, 804, 806, 808, 810, 812, 814 can describe two of more of the plurality of categories such that the user can navigate between the categories of suggested actions 816, 818, 822, 824 using the category labels 802, 804, 806, 808, 810, 812, 814 (e.g., in separate panels or pages). For example, the computing system can detect a user touch action with respect to one category label 814 and display suggested actions that correspond with the selected category label 814, for example as described below with FIG. 9.

FIG. 9 depicts the computing device 800 of FIG. 8 in which one category label 814 of the plurality of category labels has been selected. Suggested actions 822, 824 corresponding with the selected category label 814 are displayed according to aspects of the present disclosure. More specifically, in response to detecting the user touch action, the computing system can display the suggested actions 822, 824 that were categorized with respect to the selected category label 814. Thus, the artificial intelligence system can categorize the suggested actions 816, 818, 822, 824 and provide an intuitive way for the user to navigate between the categories of suggested actions 816, 818, 822, 824 for selection by the user.

In some implementations, the artificial intelligence system can rank, sort, categorize, and prioritize, etc. the suggested actions 816, 818, 822, 824 for example, based on the user data. The user data can include user preferences, calendar data (e.g., the user's plans or schedule), and/or other information about the user or the computing device. For example, the artificial intelligence system can rank the suggested actions 816, 818, 822, 824 and arrange the suggested actions 816, 818, 822, 824 within the user interface based on the ranking. Thus, the artificial intelligence system can prioritize the suggested actions 816, 818, 822, 824 and selectively display a group of the most important and/or relevant suggested actions 816, 818, 822, 824 to the user in the user interface.

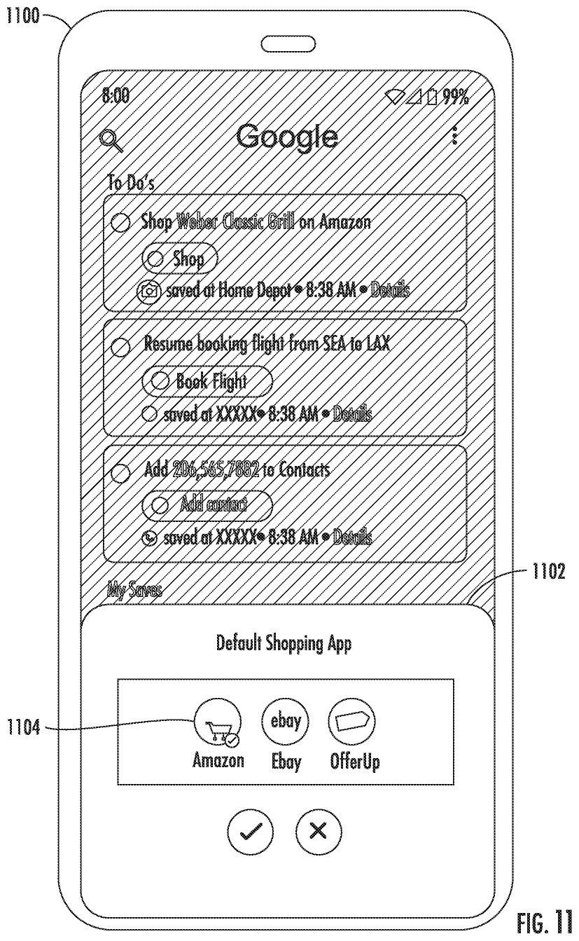

FIG. 10 depicts a computing system 1000 displaying a suggested action 1002 in which a semantic entity 1004 has been selected and a search is being performed in an overlaid panel 1006 in response to the semantic entity 1004 being selected according to aspects of the present disclosure.

FIG. 11 depicts a computing system 1100 displaying a settings panel 1102 in which the user can select a default computer application 1104 for a type of suggested action (e.g., a suggested action including shopping). The settings panel 1102 can allow the user to adjust other settings associated with the artificial intelligence system.

### Example Methods

FIG. 12 depicts a flow chart diagram of an example method 1200 for identifying information of interest, storing the information, and providing suggested actions to users of computing systems at a later time based on the stored information. Although FIG. 12 depicts steps performed in a particular order for purposes of illustration and discussion, the methods of the present disclosure are not limited to the particularly illustrated order or arrangement. The various steps of the method 1200 can be omitted, rearranged, combined, and/or adapted in various ways without deviating from the scope of the present disclosure.

At (1202), a computing system can obtain the context data during a first time interval. The artificial intelligence system can capture information of interest as the computing device is used to perform tasks throughout the day during the first time interval. For instance, the artificial intelligence system can identify and store semantic entities while the user navigates between various computer applications and/or switches between different tasks or activities.

At (1204), the computing system can input the model input that includes the context data into the one or more machine-learned models, for example as described above with reference to FIGS. 2 and 3.

At (1206), the computing system can receive, as an output of the one or more machine-learned models, the model output that describes the one or more semantic entities referenced by the context data, for example as described above with reference to FIGS. 2 and 3.

At (1208), the computing system can store the model output in a tangible, non-transitory computer-readable medium.

At (1210), the computing system can provide, for display in a user interface during a second time interval that is after the first time interval, a suggested action with respect to the one or more semantic entities described by the model output. For example, the computing system can display the suggested action at a time that is convenient for the user to review (e.g., after work, after dinner, at regularly scheduled time intervals etc.). As an example implementation, the first time interval can be defined as a duration of a call associated with a particular business. The context data can include a payment date, payment amount, or other information that was discussed during the call.

As another example, the suggested action can be displayed in response to an event (e.g., the second time interval can begin in response to the event). For example, the computing system can provide a suggested action that includes scheduling a calendar event to the user at a certain time interval prior to the event (e.g., 7 days). In some implementations the duration between obtaining the context data and providing the suggested action can be learned based on a user interaction (e.g., with prior suggested actions, with the application associated with suggested action to be provided, etc.). As a further example, a sale or lowering of a price of an item could cause the computing system to provide a suggested action with respect to the item based on context data that includes the user interacting with the item at an earlier time.

In some implementations, the suggested action(s) can be provided several hours, days, weeks, or even months after the context data was obtained. For example, the suggested action(s) can be provided at least 4 hours (or 8 hours, or longer) after the context data was obtained such that the original event that prompted obtaining the context data may not be as fresh in the mind of the user. As such, the suggested action may be more useful as a “reminder” to the user.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computing system, comprising:
at least one processor;
an artificial intelligence system comprising one or more machine-learned models, the one or more machine-learned models configured to receive a model input that comprises context data, and, in response to receipt of the model input, output a model output that describes one or more semantic entities referenced by the context data;
at least one tangible, non-transitory computer-readable medium that stores instructions that, when executed by the at least one processor, cause the at least one processor to perform operations, the operations comprising:
obtaining the context data during a first time interval;
inputting the model input that comprises the context data into the one or more machine-learned models;
receiving, as an output of the one or more machine-learned models, the model output that describes the one or more semantic entities referenced by the context data;
storing the model output in the at least one tangible, non-transitory computer-readable medium; and
providing, for display in a user interface during a second time interval that is after the first time interval, a suggested action with respect to the one or more semantic entities described by the model output.

2. The computing system of claim 1, wherein the operations further comprise generating the suggested action with respect to the one or more semantic entities described by the model output using a template.

3. The computing system of claim 2, wherein the template comprises one or more semantic entity placeholders and at least one of a verb placeholder or a computer application placeholder, and wherein generating the suggested action with respect to the one or more semantic entities described by the model output using the template comprises inserting the one or more semantic entities described by the model output into the one or more semantic entity placeholders of the template.

4. The computing system of claim 3, wherein generating the suggested action with respect to the one or more semantic entities described by the model output using the template comprises:
selecting a verb based on at least one of the context data or semantic entity; and
inserting the verb in the verb placeholder of the template.

5. The computing system of claim 3, wherein generating the suggested action with respect to the one or more semantic entities described by the model output using the template comprises:
selecting a computer application based on at least one of the context data or semantic entity; and
inserting a computer application label that describes the computer application in the computer application placeholder of the template.

6. The computing system of claim 1, wherein the operations further comprise providing, for display in the user interface during the second time interval, at least one additional suggested action that is distinct from the suggested action.

7. The computing system of claim 1, further comprising one or more computer applications, and wherein the operations further comprise:
providing, to the one or more computer applications, data descriptive of the model output; and
receiving, respectively from the one or more computer applications via a pre-defined application programming interface, one or more application outputs that describe one or more available actions from the one or more computer applications;
wherein the suggested action provided for display in the user interface describes an available action from the one or more computer applications that is based on at least one of the one or more application outputs.

8. The computing system of claim 1, wherein the operations further comprise:
obtaining additional context data that is distinct from the context data;
inputting at least one additional model input that comprises the additional context data into the one or more machine-learned models; and
receiving, as an additional output of the one or more machine-learned models, an additional model output that describes one or more additional semantic entities referenced by the additional context data.

9. The computing system of claim 1, wherein the operations further comprise:
ranking the model output with respect to at least one additional model output previously received by the one or more machine-learned models; and
arranging, within the user interface, the suggested action relative to at least one additional suggested action with respect to one or more additional semantic entities described by the additional model output.

10. The computing system of claim 1, wherein the operations further comprise:
categorizing the suggested action with respect to a plurality of categories;
displaying a plurality of category labels in the user interface that describes at least two of the plurality of categories.

11. The computing system of claim 10, wherein the operations further comprise:
detecting a user touch action with respect to one category label of the plurality of category labels; and
responsive to detecting the user touch action, displaying at least one of the suggested action or at least one additional suggested action that is categorized with respect to the one category label of the plurality of category labels.

12. The computing system of claim 1, wherein the operations further comprise providing, for display in the user interface, an explanation with respect to the suggested action, the explanation describing information about obtaining the context data.

13. The computing system of claim 12, wherein the information described by the explanation comprises at least one of a time when the context data was obtained or a location of the computing system when the context data was obtained.

14. The computing system of claim 12, wherein the information described by the explanation comprises a source from which the context data was obtained.

15. The computing system of claim 12, wherein the operations further comprise:
detecting a user touch input directed towards the explanation within the user interface;
in response to detecting the user touch input, displaying additional explanation information about obtaining the context data.

16. The computing system of claim 1, wherein the suggested action is provided for display in the user interface without receiving a user input that requests display of the user interface.

17. The computing system of claim 1, further comprising a plurality of computer applications, and wherein:
the artificial intelligence system is included in an operating system of the computing system; and
the suggested action is provided for display in response to a user input at a system level of the computing system such that the suggested action is available across the plurality of computer applications.

18. The computing system of claim 1, wherein the context data comprises at least one of information displayed in a user interface, audio played by the computing system, or ambient audio detected by the computing system.

19. A computer-implemented method for generating and providing suggested actions, the method comprising:
obtaining, by one or more computing devices, context data during a first time interval;
inputting, by the one or more computing devices, a model input that comprises the context data into one or more machine-learned models that are configured to receive the model input that comprises context data, and, in response to receipt of the model input, output a model output that describes one or more semantic entities referenced by the context data;
receiving, by the one or more computing devices, as an output of the one or more machine-learned models, the model output that describes the one or more semantic entities referenced by the context data;
storing, by the one or more computing devices, the model output in at least one tangible, non-transitory computer-readable medium; and
providing, by the one or more computing devices for display in a user interface of the one or more computing devices during a second time interval that is after the first time interval, a suggested action with respect to the one or more semantic entities described by the model output.

20. The computer-implemented method of claim 19, further comprising generating the suggested action with respect to the one or more semantic entities described by the model output using a template.
